(19) United States
(12) Patent Application Publication
(10) Pub. No.: US 2024/0166002 A1
(43) Pub. Date: May 23, 2024

(54) INTERCHANGEABLE TRAILER SYSTEM WITH BATTERY-POWERED DRIVE MECHANISM

(71) Applicant: Rustee Stubbs, Washington, UT (US)

(72) Inventor: Rustee Stubbs, Washington, UT (US)

(21) Appl. No.: 18/517,340

(22) Filed: Nov. 22, 2023

Related U.S. Application Data
(60) Provisional application No. 63/384,848, filed on Nov. 23, 2022.

(51) Int. Cl. B60D 1/24; B60D 1/64

(52) U.S. Cl. CPC B60D 1/246; B60D 1/64

(57) ABSTRACT

An interchangeable trailer system features a vehicle having a hitch receiver couplable to a hitch of a trailer, the trailer having a battery-powered drive system, wheels, and a frame. The battery-powered drive system includes an electronic control module configured to regulate a battery bank coupled to a charger, a power inverter, one or more controllers, and one or more motors, wherein the one or more motors receive coolant from a cooling system. The electronic control module has software configured to assist the vehicle and the trailer to both work in unison to optimize performance of the traction control, brakes, throttle, battery systems, and other components, as well as assist in lane changing, backing up, and adjusting to road and traffic conditions.

### CROSS-REFERENCE TO RELATED APPLICATIONS

This application claims the benefit of U.S. Provisional Application Ser. No. 63/384,848, filed Nov. 23, 2022, which is incorporated herein by reference.

### TECHNICAL FIELD

The present disclosure relates generally to trailers. More particularly, the present disclosure relates to an interchangeable trailer system with a battery-powered drive mechanism and self-driving features.

### BACKGROUND

A trailer is traditionally an unpowered vehicle towed by a powered vehicle, commonly used for the transport of goods and materials. Depending on the use, trailers have been adapted to carry cargo such as boats, recreational vehicles, livestock, construction equipment, or commercial goods. There is a need, however, in the trailer industry for a flatbed trailer that has interchangeable parts for broad use across cargo types, and that further assists in both powering and assisting the tow vehicle. While a vehicle may feature a hybrid powertrain assembly that combines a gasoline engine with an electric motor, there exists in the motor vehicle industry an unfulfilled need for a trailer with a battery-driven drive mechanism that may aid a tow vehicle having a combustion engine.

In addition, many modern electric vehicles are programmed with autopilot or full self-driving, advanced driver assistance systems that enhance safety and convenience behind the wheel. When used properly, these systems reduce the overall workload as a driver. External cameras and powerful vision processing software within the onboard computer facilitate the ease of driving while also providing an additional layer of safety. To date, however, the batteries within electric vehicles, as well as the sensors and software that enable full self-driving mode, have not been generally integrated into other vehicles such as trailers. Accordingly, there is a need for an interchangeable trailer system equipped with rechargeable batteries, sensors, controllers, motors, and software that enable it to assist the tow vehicle during transport, effectively turning internal combustion engine vehicles into hybrid electric vehicles and integrating the advanced driver assistance systems with the tow vehicle. Similarly, the need exists for an interchangeable trailer system that can further assist and augment the present capacities of current electric vehicles.

Further, there is a need for a trailer that can be adaptable to be a flatbed, box-trailer, or other type of trailer, allowing a user to change the trailer configuration without the need of having multiple trailer frames and wheels.

The present disclosure seeks to solve these problems and others.

### SUMMARY OF EXAMPLE EMBODIMENTS

In some embodiments, an interchangeable trailer system comprises a vehicle having a hitch receiver couplable to a hitch of a trailer, the trailer comprising a battery-powered drive, wheels, and a frame. The battery-powered drive comprises an electronic control module configured to regulate a battery bank coupled to a charger, a power inverter, one or more controllers, and one or more motors, wherein the one or more motors receive coolant from a cooling system. The electronic control module comprises software that is configured to assist the vehicle and the trailer to both work in unison to optimize performance of the traction control, brakes, throttle, battery systems, and other components, as well as assist in lane changing, backing up, and adjusting to road and traffic conditions.

In some embodiments, the frame of the trailer further comprises one or more support bars, the support bars comprising a plurality of pins that are couplable to a plurality of receiving inlets in a shell, the shell configured as a box trailer to store cargo.

In some embodiments, the trailer further comprises a traction control system, a theft prevention GPS control system, an anti-switch module, a support leg configured to stabilize the frame of the trailer when stationary, one or more external cameras, and a plurality of sensors configured to assist full self-driving mode.

### BRIEF DESCRIPTION OF THE DRAWINGS

FIG. 1 illustrates a side elevation view of an interchangeable trailer system;

FIG. 2 illustrates a side elevation view of a trailer;

FIG. 3 illustrates a side elevation view of a tow vehicle;

FIG. 4 illustrates a side elevation view of an embodiment of a hitch assembly;

FIG. 5 illustrates a side elevation view of an embodiment of a hitch assembly;

FIG. 6 illustrates a side elevation view of an embodiment of a hitch receiver;

FIG. 7 illustrates a rear, top, side perspective view of an embodiment of a trailer with an external shell couplable to a plurality of pins positioned on support bars;

FIG. 8 illustrates a top plan view of an interchangeable trailer system;

FIG. 9 illustrates a diagram of a battery-powered drive;

FIG. 10 illustrates a side elevation view of a tow vehicle;

FIG. 11 illustrates a top plan view of a trailer;

FIG. 12 illustrates a top plan view of a trailer; and

FIG. 13 illustrates a top plan view of a trailer.

### DETAILED DESCRIPTION OF EXAMPLE EMBODIMENTS

The following descriptions depict only example embodiments and are not to be considered limiting in scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” do not necessarily refer to the same embodiment, although they may.

Reference to the drawings is done throughout the disclosure using various numbers. The numbers used are for the convenience of the drafter only and the absence of numbers in an apparent sequence should not be considered limiting and does not imply that additional parts of that particular embodiment exist. Numbering patterns from one embodiment to the other need not imply that each embodiment has similar parts, although it may.

Accordingly, the particular arrangements disclosed are meant to be illustrative only and not limiting as to the scope of the invention, which is to be given the full breadth of the appended claims and any and all equivalents thereof. Although specific terms are employed herein, they are used in a generic and descriptive sense only and not for purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

It should be understood that the steps of any such processes or methods are not limited to being carried out in any particular sequence, arrangement, or with any particular graphics or interface. Indeed, the steps of the disclosed processes or methods generally may be carried out in various sequences and arrangements while still falling within the scope of the present invention.

The term “coupled” may mean that two or more elements are in direct physical contact. However, “coupled” may also mean that two or more elements are not in direct contact with each other, but yet still cooperate or interact with each other.

The terms “comprising,” “including,” “having,” and the like, as used with respect to embodiments, are synonymous, and are generally intended as “open” terms (e.g., the term “including” should be interpreted as “including, but not limited to,” the term “having” should be interpreted as “having at least,” the term “includes” should be interpreted as “includes, but is not limited to,” etc.).

As previously discussed, there is a need for an interchangeable trailer system with a battery-assisted drive mechanism that enables cooperative communication and dynamic interaction between a vehicle and a trailer during towing. In particular, the interchangeable trailer system disclosed herein enables a trailer to enter self-driving mode through a battery-powered drive and to assist the vehicle in steering control, lane changes, backing up, shifting, and deacceleration in relation to road conditions and traffic, among others.

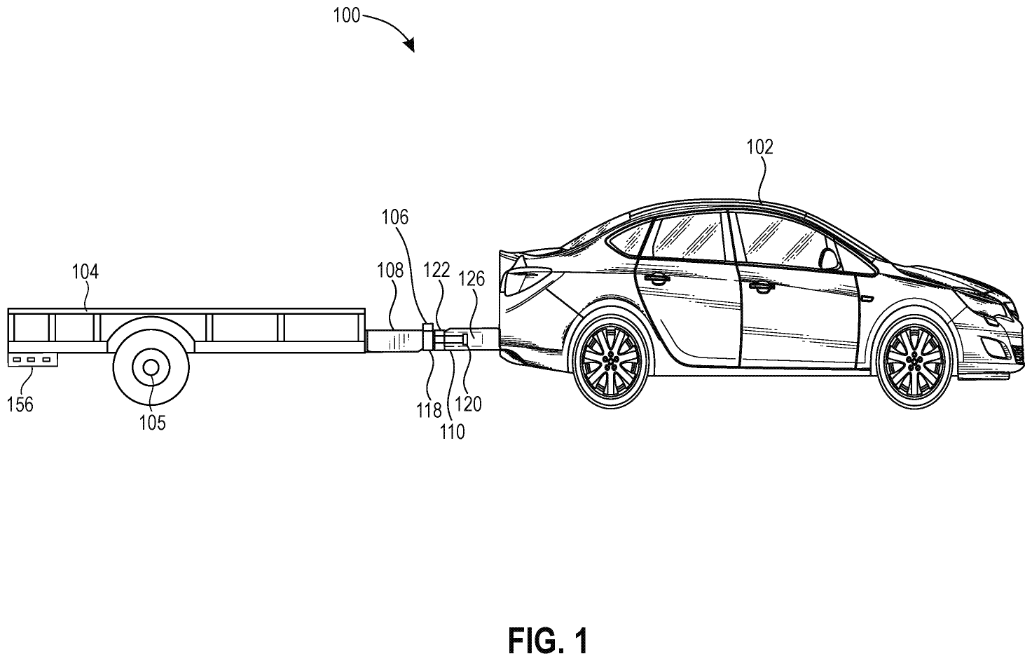

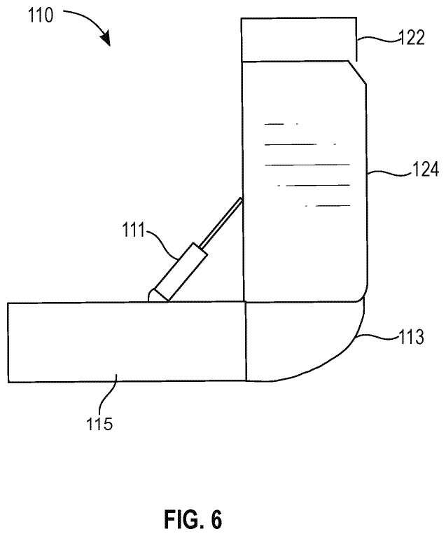

In some embodiments, as shown in FIGS. 1-3, an interchangeable trailer system 100 comprises a tow vehicle 102, a trailer 104, a drive motor 105, at least one sensor 106, a hitch 108, and a hitch receiver 110. The hitch 108 is coupled to a front end of the trailer 104 and the hitch receiver 110 is coupled to a rear end of the tow vehicle 102. With reference to FIG. 6, in some embodiments, the hitch receiver 110 is configured to automatically raise at a hinge point when the tow vehicle 102 decouples from the trailer 104, and/or may be stored underneath the chassis of the tow vehicle 102 or integrated along the rear bumper for convenient storage when not in use. This storage configuration may be either spring-activated or effectuated via an electrical or hydraulic actuator 111 that pivots a receiver tube 124 about a ball joint 113 or similar joint that effectuates pivoting of the receiver tube 124 in relation to receiver support arm 115.

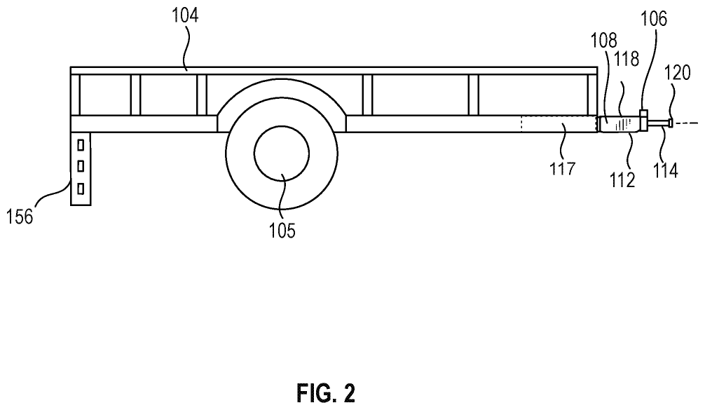

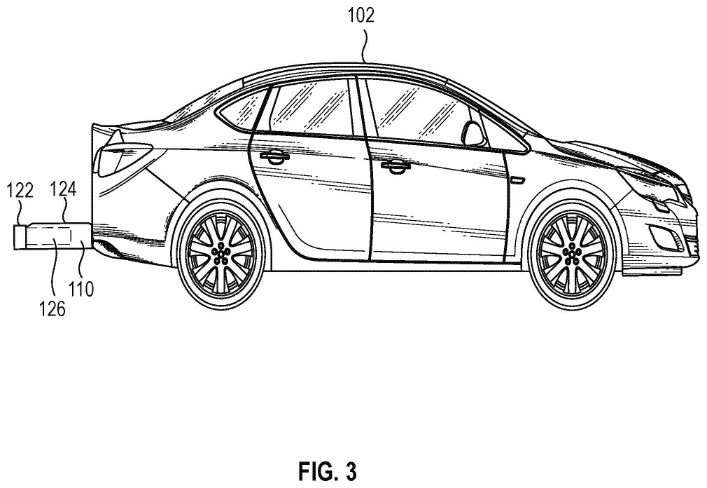

Referring back to FIG. 2, additionally, in some embodiments, the hitch 108 may withdraw, either by motor or by manual actuation, into a channel 117 in the trailer 104 for storing within a front section of the trailer 104. The hitch 108 may be secured in either the extended or withdrawn position using motors, linear actuators, locking pins, or other mechanisms. In some embodiments, the hitch receiver 110 may be removed from the tow vehicle 102 using locking pins or other known means. As shown in FIG. 3, the hitch receiver 110 is coupled to a rear end of the tow vehicle 102. During towing (FIG. 1), the hitch 108 of the trailer 104 may be mechanically coupled to the hitch receiver 110 which may be facilitated through standard towing protocols behind a tow vehicle 102.

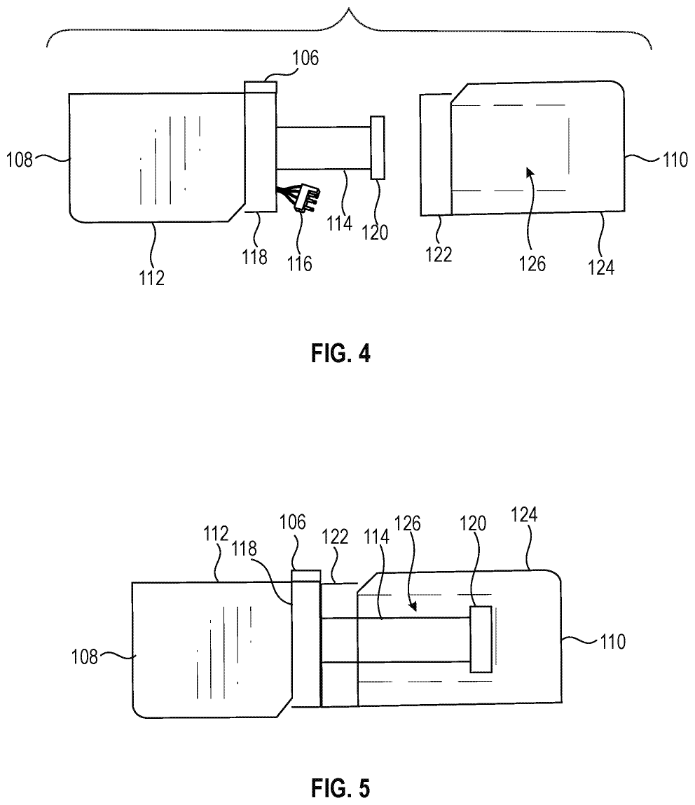

However, as best seen in FIGS. 4-5, in some embodiments, the hitch 108 comprises a housing 112, an elongated shaft 114, a wiring harness 116, a first electromagnetic plate 118, and a hitch coupler 120. In some embodiments, the hitch receiver 110 comprises a second electromagnetic plate 122 and a receiver tube 124 having an inner channel 126 configured to receive the hitch coupler 120. The first electromagnetic plate 118 is couplable to the second electromagnetic plate 122 and may be magnetically disengaged in emergency circumstances when, for example, lateral forces exceed a predetermined threshold that could otherwise cause uncontrolled whipping/swaying of the tow vehicle 102, or in situations where the tow vehicle 102 is in an accident or drives off the road. In some embodiments, the hitch coupler 120 may likewise be, or comprise, an electromagnet. While described as electromagnetic plates 118, 122, it will be appreciated that they may be electromagnets with any desired formfactor.

The full self-driving feature of the tow vehicle 102 and/or trailer 104, when enabled, paired with the decouplable electromagnetic engagement feature (i.e., 118 coupled to 122) of the interchangeable trailer system 100 removes the need for traditional safety chains and breakaway cables, although they may still be used. Alternatively, in some embodiments, the elongated shaft 114 may function as the first electromagnetic plate and magnetically couple with the second electromagnetic plate along a longitudinal axis of the inner channel 126 of the receiver tube 124. In such a scenario, the shaft 114 is sized so as to complement and slidably abut the internal walls of the channel 126 so as to be magnetically coupled when activated.

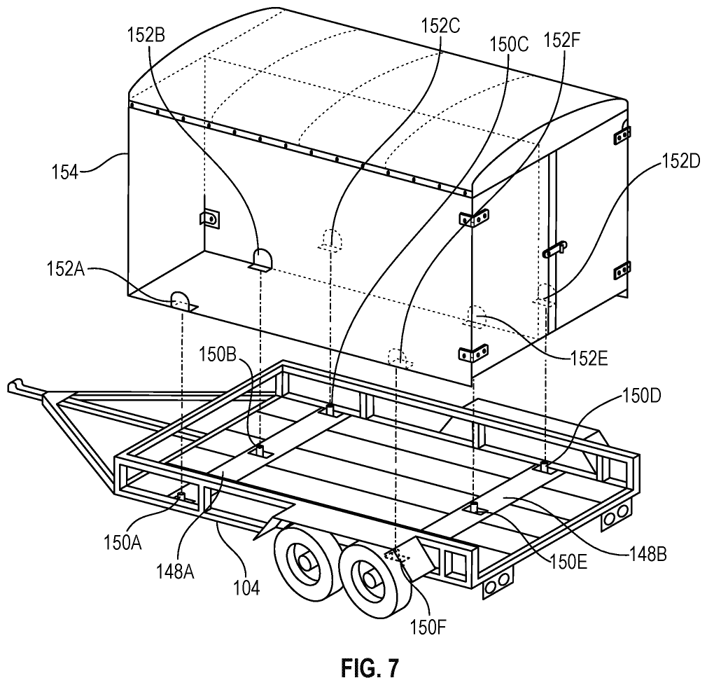

As shown in FIG. 7, in some embodiments, the trailer 104 further comprises one or more support bars 148A-B. The support bars 148A-B may be integrated with the trailer or may be bolted to a trailer for aftermarket installation. The support bars 148A-B comprise a plurality of securing pins 150A-F that may be each be couplable to a respective receiving inlet 152A-F in an external shell 154 to form a box trailer. It will be appreciated that the support bars 148A-B may be manufactured together with the trailer 104 or installed as an aftermarket add-on to an existing trailer. It is contemplated that the installation process could be performed by local mechanics or as a do-it-yourself kit. In this manner, a user may have a flatbed trailer for some uses, and a box trailer for other uses. In other words, the external shell 154 is removably attachable from the flatbed trailer using the securing pins 150A-F received through receiving inlets 152A-F. The securing pins 150A-F may be secured to the shell 154 using twist and lock securing pins, pivotable/hinged securing pins, additional securing bars and cotter pins, etc. It will be appreciated that the external shell 154 may comprise jacks or other lifting mechanisms to assist a user in removing the external shell 154 from the flatbed trailer once the pins 150A-F have been decoupled. While securing pins 150A-F have been described herein, other securing means may be used. For example, tongue and groove systems (e.g., shell 154 slides onto the bed longitudinally with tongues and grooves engaging one another, with a lock or other securing means at the rear of the trailer to prevent unwanted withdrawal), latch systems, hooks and straps (e.g., hooks positioned on both the external shell 154 and the trailer 104, with straps being secured to each pairing), etc.

In some embodiments, the trailer 104 further comprises a traction control system, a theft prevention GPS control system, an anti-switch module, at least one extendable support leg 156 (e.g., may be located at the front and rear of the trailer 104) configured to stabilize the trailer 104 when stationary, one or more external cameras, and a plurality of additional sensors configured to enable driving support for the tow vehicle 102 or full self-driving mode for relocations or other scenarios when it is detached from the tow vehicle.

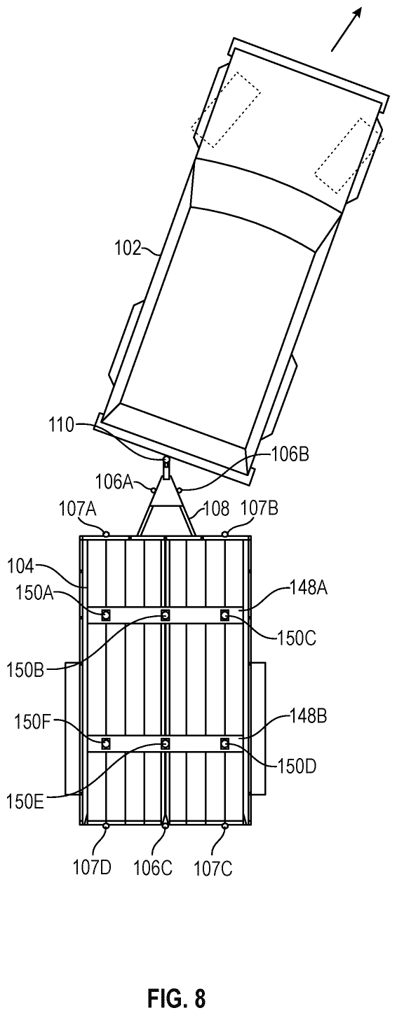

For example, referring to FIG. 8, the trailer 104 may use external cameras 107A-D and/or sensors 106A-C (e.g., proximity sensors) configured to send data to a controller, the controller configured to activate the at least one drive motor 105 to drive the wheels of the trailer 102. It will be appreciated that the trailer 104 may connect and disconnect from the vehicle 102 via the controller processing data from the proximity sensors 106A-C and cameras 107A-D to navigate the proper connection of the hitch 108 with the hitch receiver 110. In such a scenario, it will be appreciated that the hitch 108 may comprise a leg and wheel to support and drive the hitch 108 (or the at least one extendable support leg 156 may also comprise a wheel to allow for ease of driving the trailer 104 when decoupled from the tow vehicle 102). The wheel on the hitch or extendable support leg 156 may be motor-driven and steerable as well, so that a controller may maneuver the trailer 104 into the desired position. Alternatively, each wheel of the trailer 104 may be independently drivable using a respective motor 105 to allow for maneuvering.

Moreover, the distance and motion tracking data received from the interaction of the external cameras 107A-D and the sensors 106A-C may be used to identify potentially hazardous circumstances when the tow vehicle 102 should disengage from the hitch 108 on the trailer 104 or otherwise reduce the driving velocity of the two vehicles in order to avoid collisions and accidents. For example, if the tow vehicle 102 turns too sharply around a corner, or if the trailer 104 otherwise begins to sway or fishtail, the cameras 107A-D and sensors 106A-C may send data to the controller regarding the change in proximity relative to a bumper of the tow vehicle 102, with the controller configured to adjust the acceleration of the tires or braking system on the trailer 104 to restore stability and avoid any potential collision or accident. This may be accomplished using one or more controllers (e.g., electronic control module) configured to read and process data from the one or more sensors 106A-C and cameras 107A-D and execute one or more operations (e.g., speed up drive motor 105, reduce speed of motor 105, engage braking systems, disengage hitch 108 from vehicle 102, etc.).

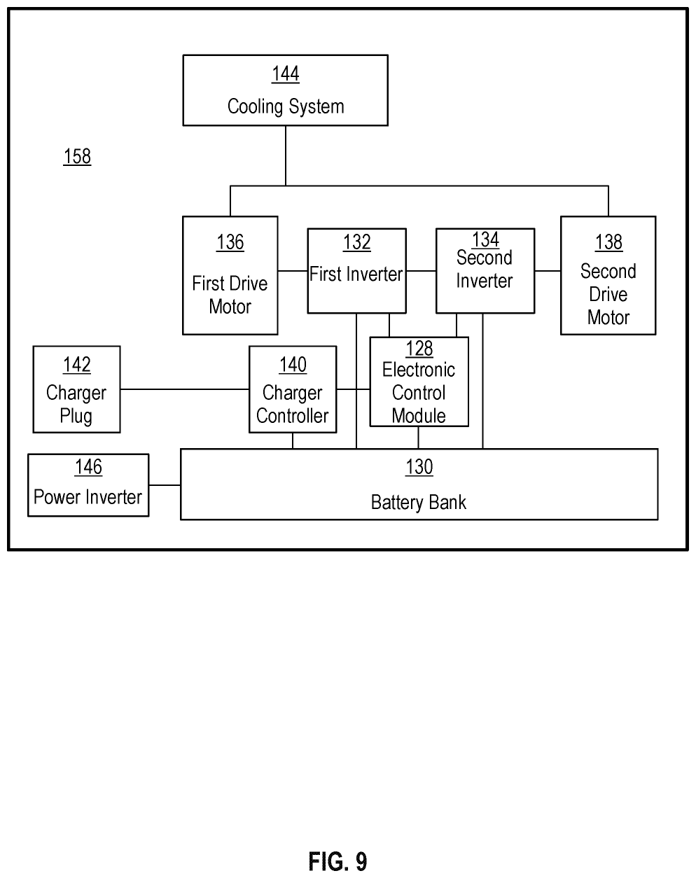

As shown in FIG. 9, the trailer 104 may comprise a battery-powered drive system 158 that comprises an electronic control module (ECM) 128 configured to regulate a battery bank 130 and one or more controllers or DC-AC power inverters 132, 134. The first inverter 132 inverts DC power from the battery bank 130 to AC power to drive a first drive motor 136 coupled to a first wheel of the trailer 104. The second inverter 134 inverts DC power from the battery bank 130 to AC power to drive a second drive motor 138 coupled to a second wheel on the opposite side of the trailer 102. The first and second drive motors 136, 138 are configured to receive coolant from a cooling system 144 to ensure they do not overheat. The battery bank 130 may be coupled to a charge controller 140 (e.g., AC to DC converter) connected to a charger plug 142 to thereby charge the battery bank 130 using AC power from a wall outlet or other source. The charge controller 140 may also be configured to manage power of other components or vehicle batteries. For example, if the voltage of the battery bank is at or above a predetermined threshold (indicating a full charge), the charge controller 140 may divert power to the vehicle 102 (such as via the wiring harness 116 or through other electrical contacts, so as to charge crank batteries, EV batteries, or other accessories. A DC to AC power inverter 146 may provide a user with accessory power on the trailer as well, when grid power is not available.

The ECM 128 comprises software that is configured to assist the vehicle 102 and the trailer 104 to both work in unison to optimize performance of the traction control, brakes, throttle, battery systems, and other components, as well as assist in lane changing, backing up, and adjusting to road and traffic conditions. For example, the electronic control module 128 may comprise a software interface that facilitates communication between the motor 105 of the trailer 104 and an electronic control module of the tow vehicle 102, wherein the software interface is configured to assist the tow vehicle 102 and the trailer 104 to work together in tandem to achieve the optimal performance of the tow vehicle 102. For example, the ECM 128 may be configured to activate one or more of: the anti-lock braking system, traction control, throttle management, battery charging systems, and/or other vehicle components. In one example of use, the ECM 128 may detect, via an ECM of the vehicle (e.g., engine control module), an RPM of the vehicle 102. If the RPM exceeds a predetermined threshold (indicating that the vehicle is going uphill or otherwise requiring a large amount of energy to tow the trailer 104), the ECM 128 can increase the speed of the trailer wheels via the motors 136, 138 so as to decrease the load on the tow vehicle 102, thereby increasing its efficiency and MPG. Likewise, when the brakes of the vehicle are activated, the ECM 128 may likewise activate the trailer brakes.

Moreover, the software may enable the tow vehicle 102 to assist the trailer 104 while reversing or while parallel parking by using the ECM 128 to control the alignment, direction, and/or speed of the wheels of the trailer 104 via the motors 105. The connection between the ECM 128 and the module on the tow vehicle 102 may be physically wired together through the wiring harness 116 on the hitch 108 and the standard towing pin connection on the tow vehicle 102. However, in some embodiments, the connection between the ECM 128 and the electronic control module on the tow vehicle 102 is wireless, wherein the connection may be through Bluetooth®, Wi-Fi®, or other known wireless communication protocols.

In an example of use, in some embodiments, a user may hitch the trailer 104 to the tow vehicle 102, wherein the tow vehicle 102 is an internal combustion engine vehicle or an electric vehicle (e.g., Tesla®). In some embodiments, the full self-driving capability of the tow vehicle 102, such as available with a Tesla®, may be utilized to aid a user in effectuating the connection (i.e., hitch 108 coupling to hitch receiver 110). Alternatively, in some embodiments, the battery-powered drive system 158 of the trailer 104 may be used to drive and position the trailer 104 for coupling with the vehicle 102, the drive system 158 in communication with the one or more sensors 106A-C and cameras 107A-D to thereby guide the trailer 104.

It will be appreciated that the drive system 158 may comprise a user interface that allows a user to control the trailer and trigger certain actions, such as engaging the one or more motors 136, 138 in preparation for coupling to a vehicle, among other actions. In some embodiments, the drive system 158 comprises a wireless transceiver and programming to allow a user to wirelessly couple their smartphone or other device to the drive system 158 to thereby control it and/or receive notifications on their smartphone or other device. In some embodiments, a user may drive the trailer 104 using the user's smartphone. For example, a joystick or other display on the graphical user interface allows a user to send input to the ECM 128, the ECM 128 activating the relevant components (e.g., motors 136, 138). In some embodiments, a user may designate a nearby vehicle 102 for the trailer 104 to connect to, with the trailer using pre-programmed software on the ECM 128 along with the sensors 106A-C and cameras 107A-D to self-drive and magnetically couple to the vehicle 102.

The ECM 128 may also control the on/off status of the one or more electromagnets 118. Accordingly, with the electromagnet 118 in the off position, a user may maneuver the trailer 104 and the electromagnet 118 to the vehicle 102. Once in position, the user may activate the electromagnet 118 via the ECM 128 (either through an onboard user input or through a wireless connection, such as a smartphone). The ECM 128 may also be programmed to provide notifications to a user to avoid unintentional disconnections or other issues. For example, if the state of charge of the battery bank 130 falls below a predetermined threshold (indicating low battery), a notification may be sent to a user (such as to their smartphone via SMS, Bluetooth®, etc.) to indicate that there is a risk that the electromagnet 118 will lose power and thereby disconnect. In some embodiments, the vehicle 102 likewise comprises an electromagnetic plate 122 to prevent unintentional de-coupling of the trailer 104 from the vehicle 102. In other words, even if the trailer battery bank 130 fails, the vehicle electromagnetic plate 122 ensures the trailer 104 remains coupled (and vice versa).

In some embodiments, a user may couple the trailer 104 to the vehicle 102 by physically driving the vehicle 102 and coupling them together. While electromagnets (118, 122) are described, it will be appreciated that the invention is not so limited and that traditional means of towing may be used, such as locking pins and cotter pins, ball and ball receiver, etc.

A wireless communication protocol or wired communication protocol (e.g., via the wiring harness 116) may be used to effectuate communication between the vehicle 102 and the trailer 104. The ECM 128 and/or the electronic control module of the vehicle includes software that assists with automatic braking systems so that the trailer 104 can assist with braking, traction control, throttle, and other components. When braking, the battery bank 130 on the trailer 104 may be charged through regenerative braking systems. It will be appreciated that such a hybridized driving connection and integrated software reduces fuel consumption and related carbon emissions.

Moreover, the interface of the full self-driving mode (of the trailer 104 and/or vehicle 102) may facilitate a safer towing experience while driving the tow vehicle 102. It will be appreciated that the electronic control module 128 (e.g., microcontroller), communication protocol (e.g., wired or wireless), and a user input/output interface (e.g., screens, buttons, lights, etc.) may allow a user to control and receive information regarding the towing of the trailer 104. Additionally, it may allow a user to engage and disengage the electromagnets (118, 122) and other components.

In some embodiments, the wiring harness 116 (or other electrical connections) may allow power to transfer between the tow vehicle 102 and the trailer 104. For example, if a trailer 104 is plugged into a power source (e.g., power grid) when parked, any excess power can flow to the tow vehicle 102 to ensure that the tow vehicle's batteries remain charged for use. In other circumstances, when grid power is not available to the trailer 104, a battery bank of the tow vehicle 102 or an alternator of the tow vehicle 102 may supply power to the trailer 104 for use and/or to charge the battery bank 130. Accordingly, it will be appreciated that the power inverter 146 may also be used to ensure AC power is available to a user. Further, a battery management system (BMS), which may be the charge controller 140 or be integrated with the charge controller 140, may be used to monitor the battery status of the battery bank 130 and other electrical components and batteries (including the vehicle batteries) and distribute power accordingly. Further, the BMS/controller may wirelessly communicate with a smartphone, or other device, allowing a user to monitor and control the battery status, charge status, etc. of the various components of the battery-powered drive system 158.

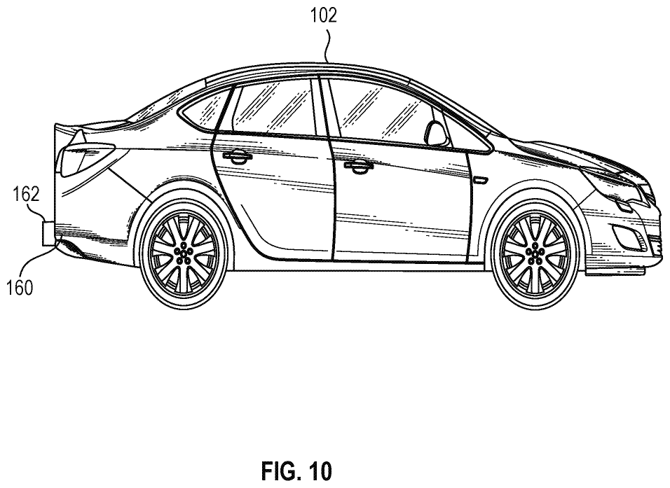

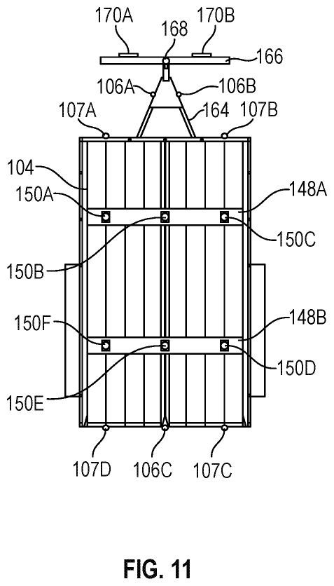

Referring to FIGS. 10-11, it will be appreciated that other arrangements may be used to facilitate coupling the trailer 104 to the vehicle 102. For example, the rear bumper 160 of the vehicle 102 may comprise electromagnets 162 incorporated therein or coupled thereto. The trailer 104 may comprise a tongue 164 with a pivot bar 166 pivotably coupled to the tongue 164 by a pivot point 168 (such as via a ball and joint or other pivot mechanism), the pivot bar 166 comprising one or more electromagnets 170A-B that are configured to magnetically couple to the electromagnets 162 or other magnetic surface of the bumper 160. While electromagnets 162 and 170A-B are used as an example, it may also be envisioned that either the trailer 104 or the vehicle 102 may have electromagnets, with the opposite side comprising a magnetic plate (e.g., iron) for coupling to the electromagnet. However, a preferred embodiment comprises electromagnets on both the trailer 104 and the vehicle 102 to better ensure against unintentional de-couplings in the event of a power loss or other malfunction of one of the electromagnets.

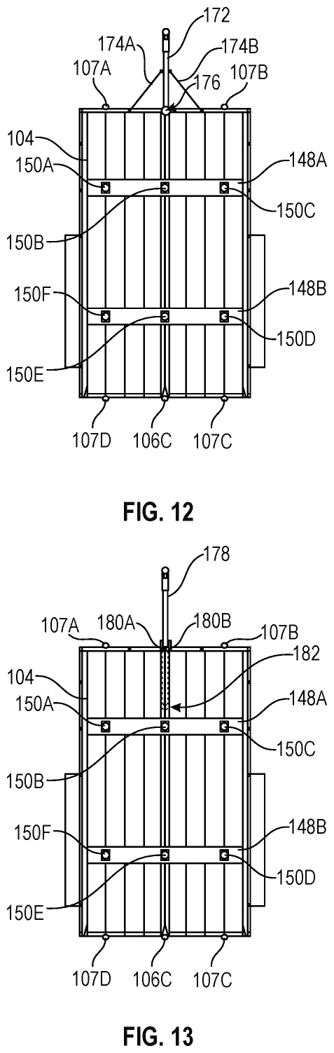

Referring to FIG. 12, the trailer 104 may comprise a tongue 172 configured to couple to a vehicle 102 (e.g., ball and receiver, electromagnets, etc.). The tongue 172 comprises one or more sensors 174A-B (e.g., pressure sensors, tension gauges, strain gauges, etc.) coupled thereto for detecting unwanted sway or other issues experienced by the trailer 104. The tongue 174 comprises a pivot point 176 to facilitate movement of the tongue 172 in relation to the trailer 104 to aid in turning and other maneuvers. The electronic control module 128 may be configured to monitor the speed of the trailer 104 and to measure the pressure/tension of the respective sensors 174A-B. Certain triggering events may be programmed using software. For example, if the trailer 104 exceeds a certain threshold speed (e.g., 40 mph) and one or more of the sensors 174A-B exceeds a certain threshold (e.g., indicating that the trailer is swaying), the electronic control module 128 may reduce the speed of the trailer 104 via the motors 136, 138 to eliminate the sway, may apply the brakes, notify a user via notification to a user display in the vehicle 102 or to a user's smartphone, or any other action capable of being programmed.

Referring to FIG. 13, the trailer 104 may comprise a tongue 178 configured to couple to a vehicle 102 (e.g., ball and receiver, electromagnets, etc.). The tongue 178 comprises one or more sensors 180A-B (e.g., pressure sensors, tension gauges, strain gauges, etc.) coupled thereto for detecting unwanted sway or other issues experienced by the trailer 104. The tongue 178 comprises a pivot point 182 to facilitate movement of the tongue 178 in relation to the trailer 104 to aid in turning and other maneuvers. The electronic control module 128 may be configured to monitor the speed of the trailer 104 and to measure the pressure/tension of the respective sensors 180A-B. Certain triggering events may be programmed using software. For example, if the trailer 104 exceeds a certain threshold speed (e.g., 40 mph) and one or more of the sensors 180A-B exceeds a certain threshold (e.g., indicating that the trailer is swaying), the electronic control module 128 may reduce the speed of the trailer 104 via the motors 136, 138 to eliminate the sway, may apply the brakes, notify a user via notification to a user display in the vehicle 102 or to a user's smartphone, or any other action capable of being programmed.

The ECM 128 is configured to monitor the status of the control modules present in vehicle (e.g., engine control module, powertrain control module, transmission control module, brake control module, central control module, central timing module, general electronic module, etc.). For example, if the ECM 128 detects activation of the braking control module of the vehicle 102, the ECM 128 can initiate the brakes or a braking control module of the trailer 104 to thereby assist the braking of the vehicle 102. In another example, if the ECM 128 detects a low gear at a high (predetermined) RPM, indicating that the vehicle 102 may be ascending a hill, the ECM 128 may increase the speed of the first and second drive motors 136, 138 of the trailer to assist the vehicle 102 by reducing the load on the vehicle 102. Additionally, the ECM 128 may activate other systems or components of the trailer, such as the lights or brakes or other components.

While electromagnets have been described herein, similar magnetic systems may be used, such as permanent magnets that are mechanically actuated using a lever (as is known in the art of lifting magnets). Additionally, prior art towing mechanisms may also be used, such as a ball and ball receiver, locking pins and cotter pins, etc. In both the permanent magnet embodiment and prior art towing embodiments, while the trailer 104 would not be capable of automatically disconnecting itself in the event of an accident, it would still be able to assist the vehicle 102 to improve towing efficiency and safety.

The ECM 128 and/or other controllers on the trailer 104 may take different forms. In its most basic configuration, a controller such as the ECM 128 includes at least one hardware processing unit (aka a “processor”), input/output (I/O) interfaces, and storage.

The ECM 128 may also be a distributed system that includes one or more connected computing components/devices that are in communication. Accordingly, the ECM 128 may be embodied in any form and is not limited to any particular embodiment explicitly shown herein.

The storage may be physical system memory, which may be volatile, non-volatile, or some combination of the two. The term “memory” may also be used herein to refer to non-volatile mass storage such as physical storage media. If the ECM 128 is distributed, the processing, memory, and/or storage capability may be distributed as well. As used herein, the term “executable module,” “executable component,” or even “component” can refer to software objects, routines, or methods that may be executed on the battery management system. The different components, modules, engines, and services described herein may be implemented as objects or processors that execute on the ECM 128 (e.g., as separate threads).

Computer storage media are hardware storage devices, such as RAM, ROM, EEPROM, CD-ROM, solid state drives (SSDs) that are based on RAM, flash memory, phase-change memory (PCM), or other types of memory, or other optical disk storage, magnetic disk storage or other magnetic storage devices, or any other medium that can be used to store desired program code means in the form of computer-executable instructions, data, or data structures and that can be accessed by a general-purpose or special-purpose computer.

The disclosed embodiments may comprise or utilize a special-purpose or general-purpose computer including computer hardware, such as, for example, one or more processors (such as the hardware processing unit, which may include one or more central processing units (CPUs), graphics processing units (GPUs) or other processing units) and system memory (such as storage).

Upon reaching various computer system components, software or program code means computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”) and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions that cause a microcontroller or general-purpose computer, special-purpose computer, or special-purpose processing device to perform a certain function or group of functions. The computer-executable instructions may be, for example, binaries, intermediate format instructions such as assembly language, or even source code.

While not all computing systems require a user interface, in some embodiments, the ECM 128 includes, as part of the I/O interfaces, a user interface for use in communicating information to/from a user. The user interface may include output mechanisms as well as input mechanisms. The principles described herein are not limited to the precise output mechanisms or input mechanisms and as such will depend on the nature of the device. However, output mechanisms might include, for instance, speakers, displays, tactile output, projections, holograms, and so forth. Examples of input mechanisms might include, for instance, microphones, touchscreens, controllers, projections, holograms, cameras, keyboards, stylus, mouse, or other pointer input, sensors of any type, and so forth. The ECM 128 may perform certain, pre-programmed functions in response to detecting certain user input.

Further, the ECM 128 may also include communication channels allowing the ECM 128 to be in wireless (e.g., Bluetooth®, Wi-Fi®, satellite, infrared, etc.) or wired communication with the battery management system and computer system of the vehicle 102, along with its networks, and/or other remote systems/devices. Remote systems/devices may be configured to perform any of the processing described with regard to the ECM 128.

In some embodiments, the ECM 128 includes computer-executable instructions (e.g., stored on storage) that enable the ECM 128 (e.g., by one or more processors executing the computer-executable instructions) to selectively activate or deactivate any portion of the trailer 104 or the vehicle 102, such as motors, brakes, lighting systems/indicators, driving modes, etc. of either or both of the trailer 104 or vehicle 102. In some instances, the ECM 128 selectively deactivates or activates at least one component of the trailer 104 or vehicle 102 in response to a triggering event. As one example, a triggering event may include detecting that the vehicle 102 is braking, with the ECM 128 initiating the braking system of the trailer 104 to thereby assist the vehicle 102 in stopping. Other triggering events may include gear to RPM ratios of the vehicle 102, power status of the vehicle 102 (whether engine is running or whether connected to grid power, for example), power status of the batteries 130 of the trailer 104, etc.

Accordingly, it will be appreciated from the foregoing that the interchangeable trailer system 100 solves the need for a trailer 104 with cooperative communication and dynamic interaction with the tow vehicle 102 and that allows a user to customize the trailer (e.g., flatbed, box trailer, etc.). In particular, the interchangeable trailer system 100 disclosed herein enables the trailer 104 to assist the tow vehicle 102 in steering control, lane changes, shifting, and deacceleration. In some embodiments, a trailer 104 may have no other purpose other than to support the tow vehicle 102.

It will be appreciated that systems and methods according to certain embodiments of the present disclosure may include, incorporate, or otherwise comprise properties or features (e.g., components, members, elements, parts, and/or portions) described in other embodiments. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment unless so stated. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

Exemplary embodiments are described above. No element, act, or instruction used in this description should be construed as important, necessary, critical, or essential unless explicitly described as such. Although only a few of the exemplary embodiments have been described in detail herein, those skilled in the art will readily appreciate that many modifications are possible in these exemplary embodiments without materially departing from the novel teachings and advantages herein. Accordingly, all such modifications are intended to be included within the scope of this invention.

What is claimed is:

1. An interchangeable trailer system, comprising:
a first electromagnet coupled to a front end of a trailer;
a second electromagnet coupled to a rear end of a vehicle;
the first and second electromagnets configured to selectively couple to one another;
wherein the trailer comprises:
a battery bank;
a first drive motor configured to drive a first wheel of the trailer; and
a second drive motor configure to drive a second wheel of the trailer.

2. The interchangeable trailer system of claim 1, wherein the trailer further comprises a tongue, the first electromagnet coupled to a distal end of the tongue.

3. The interchangeable trailer system of claim 1, wherein the trailer further comprises a hitch extending from the front of the trailer, the hitch comprising an elongated shaft receivable within a channel of a receiver tube of a hitch receiver extending rearwardly from the vehicle.

4. The interchangeable trailer system of claim 3, wherein when the elongated shaft is mated with the channel, a first electromagnetic plate on the hitch contacts a second electromagnetic plate on the hitch receiver.

5. The interchangeable trailer system of claim 1, further comprising one or more sensors on the trailer in communication with an electronic control module on the trailer, the electronic control module configured to drive the first and second drive motors.

6. The interchangeable trailer system of claim 1, further comprising one or more cameras on the trailer in communication with an electronic control module on the trailer.

7. The interchangeable trailer system of claim 1, wherein the trailer comprises an electronic control module in communication with an electronic control module of the vehicle.

8. The interchangeable trailer system of claim 1, wherein the trailer comprises a battery-powered drive system comprising the battery bank, the first and second drive motors, an electronic control module, at least one power inverter, a charge controller, and a cooling system.

9. The interchangeable trailer system of claim 8, wherein the electronic control module is in communication with one or more sensors on the trailer and one or more cameras on the trailer and is programmed to execute one or more actions based on information received from the one or more sensors and one or more cameras.

10. The interchangeable trailer system of claim 1, wherein the trailer comprises a plurality of securing pins, each configured to mate with a respective receiving inlet of an external shell, the external shell configured as a box trailer.

11. The interchangeable trailer system of claim 10, wherein the plurality of securing pins are positioned on one or more support bars configured to secure to the trailer.

12. An interchangeable trailer system, comprising:
a first electromagnet coupled to a tongue extending from a front end of trailer;
a hitch receiver extending from the rear of a vehicle, the hitch receiver comprising
a second electromagnet at a distal end, the second electromagnet being selectively couplable to the first electromagnet; and
an electronic control module on the trailer;
wherein the electronic control module is configured to:
a. control the status of the first electromagnet,
b. monitor one or more control modules of the vehicle, and
c. monitor one or more sensors of the trailer,
d. monitor one or more cameras of the trailer; and
e. control the status of one or more drive motors of the trailer.

13. The interchangeable trailer system of claim 12, wherein the one or more sensors comprise one or more proximity sensors, the electronic control module configured to determine the position of the trailer in relation to the vehicle using the one or more proximity sensors.

14. The interchangeable trailer system of claim 12, wherein the at least one electronic control module comprises a microcontroller, a transceiver, and a user input/output interface.

15. The interchangeable trailer system of claim 14, wherein the user input/output interface comprises a touchscreen.

16. The interchangeable trailer system of claim 12, wherein the trailer comprises a plurality of securing pins, each configured to mate with a respective receiving inlet of an external shell, the external shell configured as a box trailer.

17. The interchangeable trailer system of claim 16, wherein the plurality of securing pins are positioned on one or more support bars configured to secure to the trailer.

18. A method of using an interchangeable trailer system, the method comprising:
initiating an electronic control module on a trailer;
energizing a first electromagnet via the electronic control module;
coupling the trailer to a vehicle via the first electromagnet;
monitoring, via the electronic control module, one or more sensors and one or more cameras positioned on the trailer; and
in response to the electronic control module detecting one or more triggering events, activating one or more drive motors or brakes of the trailer.

19. The method of claim 18, further comprising a user maneuvering the trailer via one or more drive motors configured to drive respective wheels of the trailer.

20. The method of claim 18, wherein the electronic control module of the trailer communicates with an electronic control module on the vehicle, the electronic control module of the trailer controlling the status and speed of one or more drive motors configured to drive respective wheels of the trailer.
